(19) United States
(12) Patent Application Publication
(10) Pub. No.: US 2022/0172910 A1
(43) Pub. Date: Jun. 2, 2022

(54) Plug-In Switch Fixing Structure and Keyboard with Structure

(71) Applicant: Dongguan Gaote Electronics CO., LTD, Dongguan City (CN)

(72) Inventors: Jianqing Feng, Wenzhou City (CN); Wei Li, Nan County (CN)

(21) Appl. No.: 17/239,157

(22) Filed: Apr. 23, 2021

(30) Foreign Application Priority Data
Nov. 30, 2020 (CN) 202011374562.4

(51) Int. Cl. H01H 13/10; H01H 13/70; H01H 13/14

(52) U.S. Cl. CPC H01H 13/10; H01H 2233/086; H01H 13/14; H01H 13/70

(57) ABSTRACT

A plug-in switch fixing structure and a keyboard with the structure, and relates to the field of switch assembly technologies. The plug-in switch fixing structure includes a pin and a contact ring, where the pin is fixedly arranged on a corresponding structure, and the width of a middle portion of the pin is greater than the width of a lower end of the pin; when the pin is inserted into the contact ring, an inner side wall of the contact ring can squeeze the pin and abut against the pin; and the contact ring is fixedly arranged at a corresponding position. The keyboard includes a switch and a PCB, the switch is provided with a contact piece and a terminal, and the pin is fixedly arranged below the contact piece and/or the terminal; the PCB is provided with a hole, and the contact ring is located in the hole.

### CROSS REFERENCE TO RELATED APPLICATION

This application claims the benefit of and takes priority from Chinese Patent Application No. 202011374562.4 filed on Nov. 30, 2020, the contents of which are herein incorporated by reference.

### TECHNICAL FIELD

The present invention relates to the field of switch assembly technologies, and in particular, to a plug-in switch fixing structure and a keyboard with structure.

### BACKGROUND OF THE INVENTION

A computer is a tool that people must use in daily life, and a keyboard is one of the more important parts of today's computer equipment. The keyboard is the most commonly used and the most important input device. The keyboard can be used to input English letters, numbers, punctuation marks, etc. to the computer to issue commands and input data to the computer. The keyboard is composed of a housing, a circuit board, a mechanical shaft, a switch slot plate, etc. The mechanical shaft is the most critical part of the mechanical keyboard. At present, mechanical shafts of mechanical keyboards are mostly vertically embedded in a keyboard panel and fixed by front and rear buckles of the shaft, and pins extending out of the mechanical shaft are soldered on the PCB (Printed Circuit Board) to achieve a trigger function. The keyboard manufactured by the above process is relatively cumbersome in an assembly stage, and multiple welding will not only affect the work efficiency, but also increase production costs. In addition, when a key has a fault and needs maintenance, the keyboard switch must be disassembled, and then the pin solder is removed by heating to take out the corresponding key switch from an iron plate that fixes the keyboard, so as to perform maintenance, resulting in that the keyboard switch maintenance is time-consuming and labor-consuming.

To solve the above problems, it is necessary to develop a novel fixing structure between the keyboard and the PCB.

### SUMMARY OF THE INVENTION

An objective of the present invention is to provide a plug-in switch fixing structure and a keyboard with the structure, so as to solve the technical problems that in the prior art, it is complicated and cumbersome to assemble and disassemble the switch structure. Many technical effects achieved by preferred technical solutions among many technical solutions according to the present invention are described in detail below.

To achieve the foregoing objective, the present invention provides the following technical solutions:

A plug-in switch fixing structure according to the present invention, including a pin and a contact ring, where the pin is fixedly arranged on a corresponding structure, and the width of a middle portion of the pin is greater than the width of a lower end of the pin; when the pin is inserted into the contact ring, an inner side wall of the contact ring can squeeze the pin and abut against the pin; and the contact ring is fixedly arranged at a corresponding position.

The pin and the contact ring are fixed on corresponding structures. When the two need to be fixedly connected to each other, the pin can be inserted into the contact ring by insertion. Since the width of the middle portion of the pin is greater than the width of the lower end of the pin, the lower end of the pin can pass through the contact ring, and the middle portion of the pin and the inner side wall of the contact ring squeeze and abut against each other. In this case, the pin and the contact ring can be fixedly connected together. In this case, the corresponding switch can be easily installed and dismantled through the pin and the contact ring.

On the basis of the above technical solution, the present invention can further be improved as follows.

As a further improvement of the present invention, contact surfaces of the pin and the contact ring are made of a conductive metal.

As a further improvement of the present invention, the pin has a plat structure, the middle portion of the pin is provided with a hollow structure, and left and right sides of the hollow structure extend outward to form protruding parts; or, at least one side of the pin in a width direction extends in a direction away from the contact ring to form a bifurcated structure.

Due to the presence of the protruding parts, the width of the middle portion of the pin is greater than the width of the lower end of the pin. When the pin is squeezed by the inner side wall of the contact ring, the middle portion of the pin can have a certain deformation toward the hollow structure under the action of the squeezing force, so as to make the two abut against each other.

As a further improvement of the present invention, the hollow structure extends downward to a lower end of the pin to form an opening.

Further, the number of the bifurcated structures is two; in addition, the middle portion of the pin is recessed in a direction away from the bifurcated structure to form an accommodating space for deformation.

Further, the pin includes a fixing piece and a squeezing piece fixedly arranged on one side of the fixing piece; and when the pin is inserted into the contact ring, the squeezing piece is deformed due to squeezing and deflects towards the fixing piece.

As a further improvement of the present invention, one end of the squeezing piece is fixedly connected to the fixing piece, the other end thereof extends toward an upper end of the fixing piece and points to the fixing piece, at this time a bending area exists on the squeezing piece, and the bending area is located at a middle portion of the squeezing piece.

As a further improvement of the present invention, both upper and lower ends of the squeezing piece are fixedly connected to the fixing piece, and at this time, a middle portion of the squeezing piece is bent in a direction away from the fixing piece.

As a further improvement of the present invention, the fixing piece has a flat plate-shaped structure, or a middle portion of the fixing piece is bent in a direction away from the squeezing piece.

As a further improvement of the present invention, a projection of the inner side wall of the contact ring in a vertical direction includes at least one of a circular structure and a strip-shaped structure.

The present invention further provides a keyboard, including any one of the above plug-in switch fixing structures. The keyboard includes a switch and a PCB, the switch is provided with a contact piece and a terminal, and the pin is fixedly arranged below the contact piece and/or the terminal; the PCB is provided with a hole, and the contact ring is located in the hole.

The keyboard structure includes the switch and the PCB, where the pin is located on the switch, the contact ring is located on the PCB, and the pin cooperates with the contact ring to firmly fix the switch to the PCB, facilitating the installation and dismantling of the switch.

Compared with the prior art, the present invention provides a plug-in switch fixing structure and a keyboard with the structure, where a pin connected to the switch and a contact ring connected to a PCB are fixed to corresponding positions respectively. When the pin and the contact ring need to be connected together, the pin can be inserted in the contact ring in a squeezed and inserted manner. In this case, the switch and the PCB implement the circuit signal connection through the pin and the contact ring, so that the switch can be controlled to be on or off. In addition, compared with a conventional fixing structure, the plug-in switch fixing structure is more convenient to install and dismantle, can greatly simplify a manufacturing process, reduces production costs of raw materials, and is also convenient to maintain.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other accompanying drawings from these accompanying drawings without creative efforts.

FIG. 1 is an overall schematic diagram of a plug-in switch fixing structure according to the present invention;

FIG. 2 is a schematic structural diagram of a pin in FIG. 1;

FIG. 3 is a second schematic structural diagram of the pin in FIG. 1;

FIG. 4 is a third schematic structural diagram of the pin in FIG. 1;

FIG. 5 is a fourth schematic structural diagram of the pin in FIG. 1;

FIG. 6 is a fifth second schematic structural diagram of the pin in FIG. 1;

FIG. 7 is a sixth schematic structural diagram of the pin in FIG. 1;

FIG. 8 is a seventh schematic structural diagram of the pin in FIG. 1;

FIG. 9 is a fourth schematic structural diagram of the pin in FIG. 1;

FIG. 10 is a schematic structural diagram of a contact ring in FIG. 1;

FIG. 11 is a second schematic structural diagram of the contact ring in FIG. 1;

FIG. 12 is a schematic diagram of the installation of a keyboard according to the present invention;

FIG. 13 is a schematic partial cross-sectional structural diagram of a keyboard according to the present invention;

FIG. 14 is a second schematic partial cross-sectional structural diagram of a keyboard according to the present invention;

FIG. 15 is a schematic structural diagram of a PCB in a keyboard according to the present invention;

FIG. 16 is a second schematic structural diagram of a PCB in a keyboard according to the present invention;

FIG. 17 is a third schematic structural diagram of a PCB in a keyboard according to the present invention; and

FIG. 18 is a schematic diagram of the overall structure of a keyboard according to the present invention.

In the figure: 1. Pin; 11. Hollow structure; 12. Protruding part; 13. Opening; 14. Fixing piece; 15. Squeezing piece; 151. bending area; 16. Bifurcated structure; 161. Accommodating space; 2. Contact ring; 3. Switch; 4. PCB; 41. Hole.

### DETAILED DESCRIPTION OF THE SEVERAL EMBODIMENTS

To make the objective, technical solution and advantages of the present invention clearer, the following describes the technical solutions of the present invention in detail. Apparently, the described embodiments are merely some rather than all of the embodiments of the present invention. All other implementations obtained by a person of ordinary skill in the art based on the embodiments of the present invention without creative efforts shall fall within the protection scope of the present invention.

In the description of the present invention, it should be understood that the orientation or positional relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, etc. are based on orientation or positional relationships shown in the accompanying drawings. It is only for the convenience of describing the present invention and simplifying the description, and does not indicate or imply that the referred device or element must have a specific orientation and be constructed and operated in a specific orientation. Therefore, it cannot be understood as limiting the present invention. Moreover, the terms such as “first”, “second” and “third” are used only for the purpose of description and are not intended to indicate or imply relative importance.

In the description of the present invention, it should be further noted that, unless otherwise clearly specified and limited, meanings of terms “install”, “connected with”, and “connected to” should be understood in a board sense. For example, the connection may be a fixed connection, a removable connection, or an integral connection; may be a mechanical connection or an electrical connection; or may be a direct connection or an indirect connection by using an intermediate medium. A person of ordinary skill in the art may understand specific meanings of the above terms in the present invention based on a specific situation.

The technical solutions of the present invention are further described in detail below with reference to the accompanying drawing.

The present invention provides a plug-in switch fixing structure, including a pin 1 and a contact ring 2. In use, the pin 1 and the contact ring 2 are respectively fixedly arranged on two relatively independent structures that need to be electrically connected, as shown in FIG. 1. Specifically, the width of a middle portion of the pin 1 is greater than the width of a lower end thereof, and a certain deformation can occur when the width of the middle portion is squeezed. When the pin 1 is inserted into the contact ring 2, the lower end of the pin 1 directly passes through the contact ring 2, and the middle portion is squeezed by the contact ring 2 to have a certain deformation and thus abuts against an inner side wall of the contact ring 2.

The pin 1 and the contact ring 2 are fixed on the corresponding structures. When the two need to be fixedly connected to each other, the pin 1 can be inserted into the contact ring 2 by insertion. Since the width of the middle portion of the pin 1 is greater than the width of the lower end of the pin 1, the lower end of the pin 1 can pass through the contact ring 2, and the middle portion of the pin 1 and the inner side wall of the contact ring 2 squeeze and abut against each other. In this case, the pin 1 and the contact ring 2 can be fixedly connected together. In this case, the corresponding switch 3 can be easily installed and dismantled through the pin 1 and the contact ring 2.

Compared with the conventional welding, the structure not only saves machining materials, but also is more convenient and efficient in the connection and dismantling process, and can effectively improve the machining efficiency. In addition, once an installation error occurs, it is easy to perform modification and remediation.

It should be noted that, to ensure the circuit connection, the pin 1 and the contact ring 2 are preferably made of a conductive metal material. At least, contact surfaces of the pin 1 and the contact ring 2 are made of a conductive metal material.

The pin 1 has a variety of structures, which may be a plat structure or a partially bent curved surface structure. The specific structure is as follows:

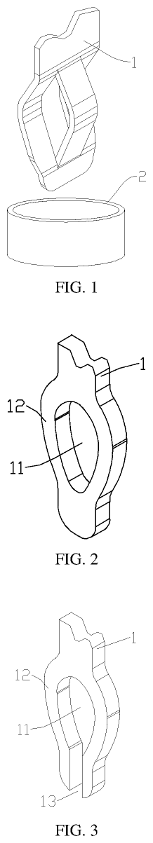

When the pin 1 has a plat structure, to ensure that it has a certain squeezing and deformation effect, the middle portion thereof has a hollow structure 11, and two ends of the hollow structure 11 extend outward to form protruding parts 12, as shown in FIG. 2. When the pin 1 is inserted into the contact ring 2, the protruding parts 12 are squeezed and deformed toward the hollow structure 11 at the middle portion.

Due to the presence of the protruding parts 12, the width of the middle portion of the pin 1 is greater than the width of the lower end of the pin 1. When the pin 1 is squeezed by the inner side wall of the contact ring 2, the middle portion of the pin 1 can have a certain deformation toward the hollow structure 11 under the action of the squeezing force, so as to make the two abut against each other.

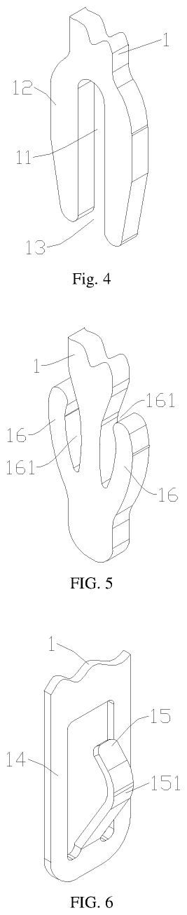

In order to make the deformation effect of the structure better, the hollow structure 11 can extend toward the bottom of the pin 1 until an opening 13 structure is formed at the lower end of the pin 1, as shown in FIGS. 3 and 4. In this case, when the protruding part 12 is squeezed, the protruding part 12 deflects toward the opening 13, and the opening 13 becomes small due to squeezing.

Specifically, the width of the opening 13 is not greater than the width of the hollow structure 11.

In addition, the pin 1 may be a plat object with a bifurcated structure 16; or, at least one side of the pin 1 in a width direction can extend in a direction away from the contact ring 2 to form a bifurcated structure 16. That is, any one of the left and right sides of the pin 1 may form a bifurcated structure 16. When the bifurcated structures 16 are formed on both sides of the pin 1, the pin 1 is provided with two bifurcated structures 16.

In order to ensure that the bifurcated structure 16 can have a better deformation effect, the deformation amount in the width direction of the pin 1 is relatively small. In this case, the middle portion of the pin 1 is recessed in the direction away from the bifurcated structure 16 to form an accommodating space 161 for the deformation of the bifurcated structure, as shown in FIG. 5.

When the pin 1 has a partially bent curved surface structure, in order to ensure a certain squeezing and deformation effect, the pin 1 includes a fixing piece 14 and a squeezing piece 15 fixedly arranged on one side of the fixing piece 14; and when the pin 1 is inserted into the contact ring 2, the squeezing piece 15 is squeezed and deformed and deflects toward the fixing piece 14.

It should be noted that in order to ensure that the squeezing piece 15 does not affect the disassembly of the pin 1 and the contact surface, a bending area 151 needs to be set on the squeezing piece 15, and the bending area 151 makes an upper end of the squeezing piece 15 toward the fixing piece 14.

As shown in FIG. 6, in this case, the fixing piece 14 has a plat structure. One end of the squeezing piece 15 is fixedly connected to the fixing piece 14, and the other end thereof extends toward the upper end of the fixing piece 14 and points to the fixing piece 14. In this case, the bending area 151 is located at a middle portion of the squeezing piece 15.

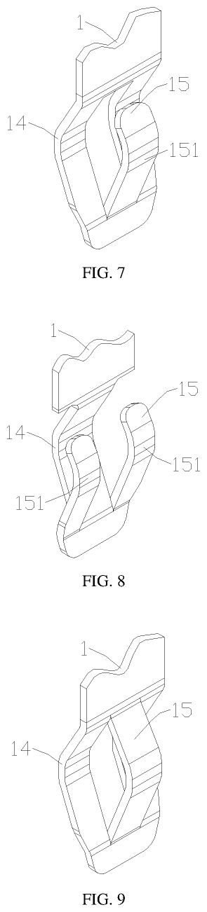

Or, as shown in FIGS. 7 and 8, the fixing piece 14 has a bent structure with a bent middle portion, and the middle portion is bent in a direction away from the squeezing piece 15; one end of the squeezing piece 15 is fixedly connected to the fixing piece 14, the other end thereof extends toward the upper end of the fixing piece 14 and points to the fixing piece 14, and the bending area 151 is located at a middle portion of the squeezing piece 15.

Besides that the lower end of the squeezing piece 15 is fixedly connected to the fixing piece 14, the upper end thereof may also be fixedly connected to the fixing piece 14. As shown in FIG. 9, the upper and lower ends of the squeezing piece 15 are both fixedly connected to the fixing piece 14, and middle portions of both the squeezing piece 15 and the fixing piece 14 are bent in directions away from each other. In this case, the width of the middle portion of the pin 1 is greater than the width of the lower end of the pin 1. When the pin 1 is inserted in the contact ring 2 and squeezed by the contact ring 2, a bent part is squeezed to have a certain deformation towards the inner side and abuts against the inner side wall of the contact ring 2.

It should be noted that, in order to facilitate machining and ensure the strength of the pin 1, the fixing piece 14 and the squeezing piece 15 are both integrated. The pin 1 is formed by machining a plat structure, and the middle portion and two sides thereof are bent in different directions respectively.

The inner side wall of the contact ring 2 is made of a conductive metal material.

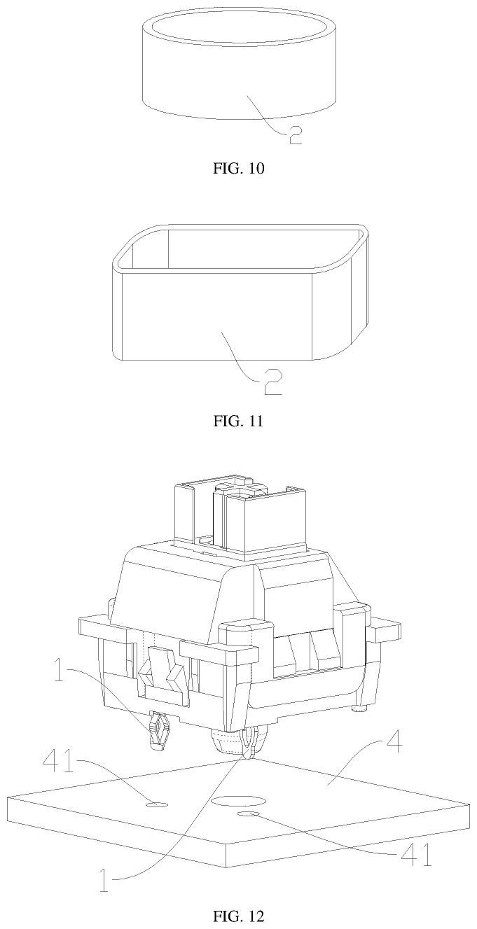

Specifically, the contact ring 2 may be in various shapes. In order to match pins 1 with different structures, a projection of the contact ring 2 in a vertical direction may have a circular structure or a strip-shaped structure. The strip-shaped structure includes a rounded rectangle or another similar structure, as shown in FIG. 10 and FIG. 11.

The above plug-in switch fixing structure can be applied to various switch 3 structures, taking a commonly used keyboard as an example.

As shown in FIG. 12, the keyboard includes a plug-in switch fixing structure. Specifically, the keyboard includes a switch 3 and a PCB 4, the switch 3 is provided with a contact piece and a terminal, and the pin 1 is fixedly arranged below the contact piece and/or the terminal; the PCB is provided with a hole 41, and the contact ring 2 is embedded in the hole 41.

The keyboard structure includes the switch 3 and the PCB 4, where the pin 1 is located on the switch 3, the contact ring 2 is located on the PCB 4, and the pin cooperates with the contact ring to firmly fix the switch 3 to the PCB, facilitating the installation and dismantling of the switch 3.

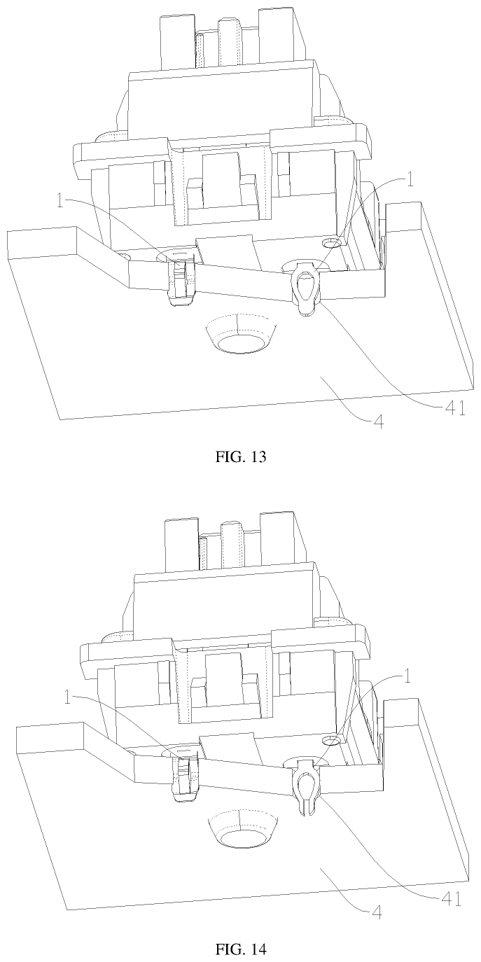

The installation structure is shown in FIG. 13 and FIG. 14.

Specifically, the pin 1 includes a variety of different structures. In order to facilitate the installation, the pins 1 located below the contact piece and the terminal of the same switch 3 have different structures.

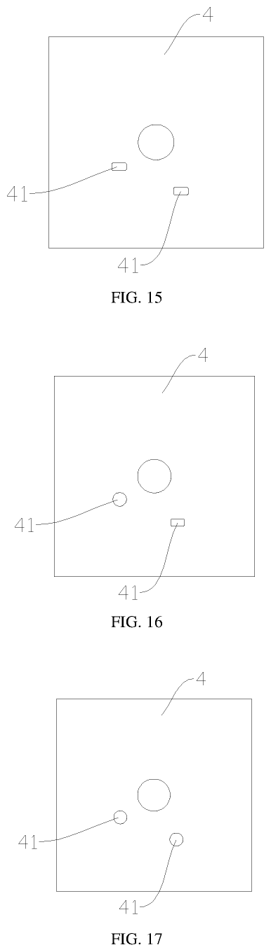

In addition, in order to fit the pins 1 of different shapes and the contact rings 2 that can match the pins 1, corresponding opening in the PCB 4 are not completely the same in shape, as shown in FIG. 15 to FIG. 17.

The pin 1 can connect the switch 3 with the PCB 4 by using a contact mode of physical squeezing force, and a metal surface on the inner wall of the hole 41 is used to implement the circuit signal connection. On the premise that the use function of the switch 3 is not changed, the manufacturing process can be greatly simplified and the raw material production cost can be reduced.

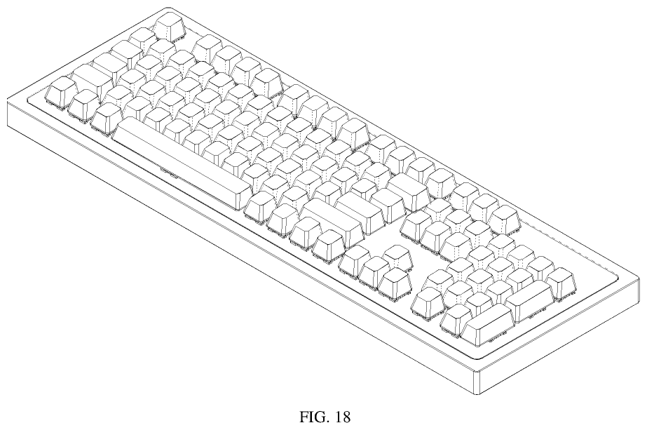

Compared with the keyboard switch 3 that is fixed by conventional welding, the keyboard switch 3 is more convenient to install and dismantle. In addition, since no welding process is required, auxiliary solder, a soldering flux and other accessories are also omitted in the machining process, and the machining cost and construction difficulty are effectively reduced. The overall structure of the keyboard machined by using this structure is shown in FIG. 18.

The above descriptions are only specific implementations of the present invention, but the protection scope of the present invention is not limited thereto. Any person skilled in art can easily conceive of variations or replacements within the technical scope disclosed in the present invention, and the variations or replacements should fall within the protection scope of the present invention. Therefore, the protection scope of the present invention should be subject to the claims.

What is claimed is:

1. A plug-in switch fixing structure, comprising a pin and a contact ring, wherein the pin is fixedly arranged on a corresponding structure, and the width of a middle portion of the pin is greater than the width of a lower end of the pin;
when the pin is inserted into the contact ring, an inner side wall of the contact ring can squeeze the pin and abut against the pin; and the contact ring is fixedly arranged at a corresponding position.

2. The plug-in switch fixing structure according to claim 1, wherein contact surfaces of the pin and the contact ring are made of a conductive metal.

3. The plug-in switch fixing structure according to claim 1, wherein the pin has a plat structure, the middle portion of the pin is provided with a hollow structure, and left and right sides of the hollow structure extend outward to form protruding parts;
or, at least one side of the pin in a width direction extends in a direction away from the contact ring to form a bifurcated structure.

4. The plug-in switch fixing structure according to claim 3, wherein the hollow structure extends downward to a lower end of the pin to form an opening.

5. The plug-in switch fixing structure according to claim 1, wherein the pin comprises a fixing piece and a squeezing piece fixedly arranged on one side of the fixing piece; and when the pin is inserted into the contact ring, the squeezing piece is deformed due to squeezing and deflects towards the fixing piece.

6. The plug-in switch fixing structure according to claim 5, wherein the squeezing piece has two ends, one end of the squeezing piece is fixedly connected to the fixing piece, the other end thereof extends toward an upper end of the fixing piece and points to the fixing piece, at this time a bending area exists on the squeezing piece, and the bending area is located at a middle portion of the squeezing piece.

7. The plug-in switch fixing structure according to claim 5, wherein both upper and lower ends of the squeezing piece are fixedly connected to the fixing piece, and at this time, a middle portion of the squeezing piece is bent in a direction away from the fixing piece.

8. The plug-in switch fixing structure according to claim 7, wherein the fixing piece has a flat plate-shaped structure, or a middle portion of the fixing piece is bent in a direction away from the squeezing piece.

9. The plug-in switch fixing structure according to claim 1, wherein a projection of the inner side wall of the contact ring in a vertical direction comprises at least one of a circular structure and a strip-shaped structure.

10. A keyboard, comprising the plug-in switch fixing structure according to claim 1, wherein the keyboard comprises a switch and a PCB, the switch is provided with a contact piece and a terminal, and the pin is fixedly arranged below the contact piece and/or the terminal;
the PCB is provided with a hole, and the contact ring is located in the hole.
